(19) United States
(12) Patent Application Publication
(10) Pub. No.: US 2014/0345145 A1
(43) Pub. Date: Nov. 27, 2014

(54) SLIP JOINT

(71) Applicants: Spencer Frazer, Lynnwood, WA (US); Beren McKay, Lynnwood, WA (US)

(72) Inventors: Spencer Frazer, Lynnwood, WA (US); Beren McKay, Lynnwood, WA (US)

(21) Appl. No.: 14/214,732

(22) Filed: Mar. 15, 2014

Related U.S. Application Data
(60) Provisional application No. 61/794,927, filed on Mar. 15, 2013.

(51) Int. Cl. B26B 1/04

(52) U.S. Cl. CPC B26B 1/044
USPC 30/161

(57) ABSTRACT

A knife with an asymmetric slip joint is disclosed. In some embodiments,

[symbol]

### RELATED APPLICATIONS

This application claims the benefit of U.S. Provisional Application No. 61/794,927, filed Mar. 15, 2013.

### BACKGROUND

Currently, slip joints for knives use a flat leaf spring that contacts a flat portion of a tang of a knife blade. In this arrangement, the force of the leaf spring acting on the flat part of the tang holds the knife blade open until enough closing force is exerted to overcome the spring force. However, if the blade is long then a user can exert a large moment on the pivot of the blade and the slip joint will feel weak and unstable or may not sufficiently hold a knife blade open.

One approach to counter a large moment acting on the open blade is to increase the spring force of the leaf spring. However, by increasing the spring force the knife becomes considerably harder to open since the spring exerts the same force on the blade in the open and shut positions and most opening holds on blades are only a portion of the way up the blade, thereby providing considerably less leverage than is typically used to close the blade.

### SUMMARY

Accordingly, a slip joint for a knife or other implement is described below in the Detailed Description. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a plan view of a knife having an embodiment slip joint with the blade in an open position.

FIG. 2 is a section view of a knife having an embodiment slip joint with the blade in an open position and the slip joint engaging the blade tang.

FIG. 3 is a section view of a knife having an embodiment slip joint with the blade in a partially open position.

FIG. 4 is a section view of a knife having an embodiment slip joint with the blade in a closed position and the slip joint engaging the blade tang.

FIG. 5 is a section view of a knife having an embodiment slip joint with the blade in an open position.

FIG. 6 is a section view of a knife having an embodiment slip joint with the blade in a closed position.

FIG. 7 is a section view of a knife having an embodiment slip joint with the blade in an open position.

FIG. 8 is a section view of a knife having an embodiment slip joint with the blade in a closed position.

### DETAILED DESCRIPTION

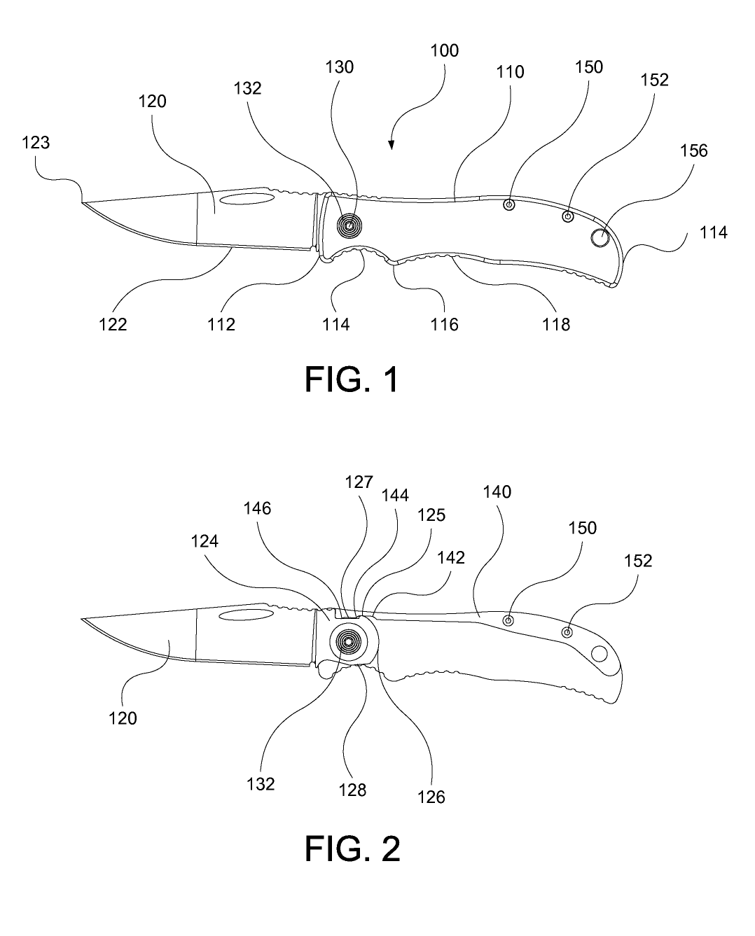

FIG. 1 is a plan view of a knife 100 having an embodiment slip joint with the blade 120 in an open position. Knife 100 includes a blade 120 in the handle 110. Blade 120 is pivotably connected to handle 110 at pivot 130. In an alternate embodiment, pivot 130 may additionally have a spring 132 to assist in opening or closing blade 120. In the present embodiment blade one-time 20 includes a knife point 123, a knife edge 122, a tang 124, and that came includes a recess 127 a radius or cam surface 126 and a flat surface 128 on the front of the blade. Handle 110 includes a finger guard 112, a finger grip 114, a contour 116, a textured gripping surface 118, a base 114, a surface 156 defining a hole through the handle, and connector 150 and connector 152 to fasten sides of the handle together. However knife 100 is an exemplary knife and other folding knives may use the disclosed slip joint without being limited to any of the other features of knife 100. We now turn to FIG. 2 to discuss the slip joint.

FIG. 2 is a section view of a knife 100 having an embodiment slip joint with the blade 120 in an open position and the slip joint engaging the blade tang 124. Knife 110 includes a lockback bar 140 fasten to the handle with connector 150 and connector 152. Lockback bar 140 has an engaging surface including convex surface 146, convex surface 144, and indention 142. The tang of blade 120 includes a concave portion 127 prominent surface 125, radius or cam surface 126, and flat surface 128. In FIG. 2 the blade 120 is an open orientation and lockback bar 140 is engaging concave portion 127. In a slip joint knife, such as knife 100, lockback bar 140 does not positively lock blade 120 in an open or closed position, but provides a resistance to rotation of blade 120. In the present embodiment, the slip joint uses a lockback bar 140, however other embodiments may use other structure such as rocker arms, flat springs or other structures suitable for a slip joint.

In general, a slip joint knife has a flat surface on the lockback bar and on both sides of the tang 124. While this flat surface provides a resistance to rotation while the blade is in the closed position or in the open position it makes enough it makes a knife more difficult to open as the moment arm to open the knife is shorter than the one used to close it. In the present embodiment, lockback bar 140 does not have a flat surface engaging the knife tang but has a one or more convex surfaces engaging a concave surface in the knife tang. For example, a convex surface may be a dimple, a bump, a latch, a wedge, or some other geometric shape. The concave surface in the knife tang may be a corresponding indentation to the dimple, bump, latch, wedge or other geometric shape.

In this way, I embodiment slip joint may resist rotation more than a flat surface slip joint, but resist rotation less than positively locking structure. For example, first convex surface 146 fits within concave surface 127 such that the blade 120 has to overcome a spring force and a structural obstacle in order to close. As the angle of the intersecting concave and convex portions approaches a line perpendicular to the length of the handle, lockback bar 140 approaches a locking mechanism.

Therefore to overcome the different moment arms that cause a conventional slip joint knife to have more difficulty opening and closing, and embodiment slip joint knife can have a slightly more locking geometry between the lockback bar 140 and indentation 127 when the knife is in an open orientation than the corresponding geometry between lockback bar 140 and surface 128 on the front of the blade when the knife is in a closed orientation.

In some embodiments, a slip joint knife includes a handle 110 having an opening to receive a blade 120, and a lockback bar 140 having an engagement surface, a pivot pin connected toward one end of the handle, the pivot pin to receive a blade, and a blade to be rotatably attached to the handle using the pivot pin, the blade comprising a knife edge and a tang, wherein the tang includes a front portion and a rear portion where the front portion is on the knife edge side of the blade and the rear portion is on a substantially opposing surface of the tang, where the front portion has a substantially flatter geometry than the rear portion wherein the engagement surface of the tang provides a greater rotational resistance when in contact with the rear portion than with the front portion.

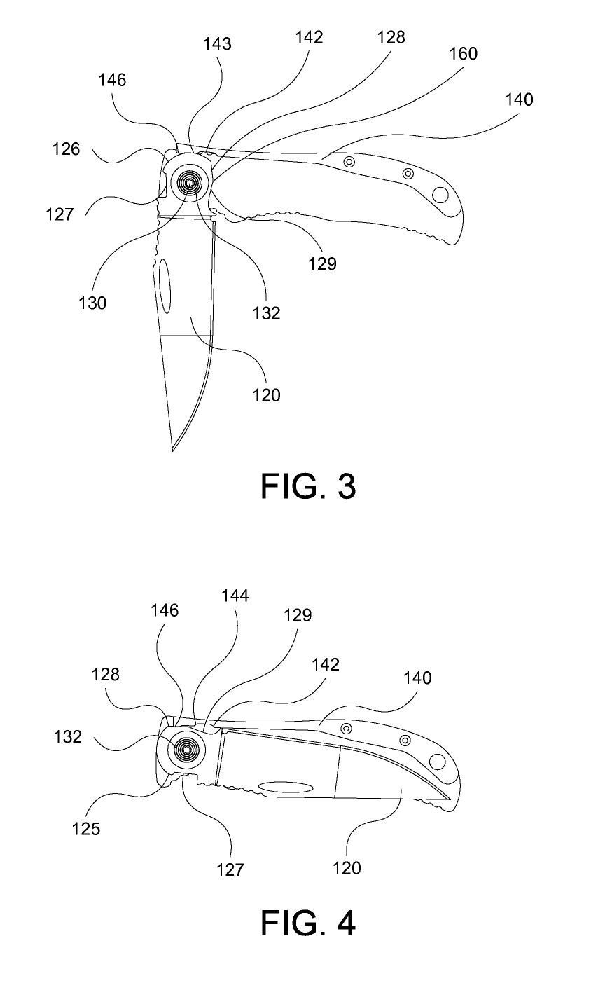

FIG. 3 is a section view of one embodiment knife 100 having a slip joint with the blade 120 in a partially open position. In this orientation, blade 120 has been turned so first convex surface 146 is no longer adjacent to indentation 127 and is on cammed or radiused surface 126. With reference to the illustration, neither first convex surface 146, nor indentation 142 are touching the tang of blade 120. In this position, lockback bar 140 flexed as a cantilevered spring as the blade 120 rotated from the open orientation. FIG. 3 additionally illustrates surface 128 on the front of the tang, point 160 on the front of the tang, a choil 129 on the front of the tang near the blade. Choil 129 is a safety feature to protect a finger if blade 120 is closed for the knife handle is being held. In some embodiments, choil 129 may include a finger guard between the choil and in the sharp edge of the knife. Additionally, the finger guard may serve as a blade stop when the knife 120 is in a closed position, as depicted in FIG. 4.

FIG. 4 is a section view of an embodiment knife 100 having a slip joint with the blade 120 in a closed position and the slip joint engaging surface 128 on the blade tang 124. In this orientation, lockback bar 140 is pressing against surface 128 in a manner similar to a flat surface slip joint. That is, when the blade 120 is in a closed position, the slip joint functions more as a flat surface slip joint to allow easier rotation to the open position, and when the blade 120 is in an open position the corresponding convex and concave geometry between the lockback bar in the tang indentation 127 functions more as a locking mechanism but without positively locking the blade in the open orientation.

In some embodiments, the surface geometry of lockback bar 140 that corresponds to indentation 127, may not contact indentation 127 in a continuous fashion. For example, lockback bar 140 may have multiple surface geometries such as first con convex portion 146 and second convex portion 144, such that there are multiple angles of blade 120 that have more resistance to rotation.

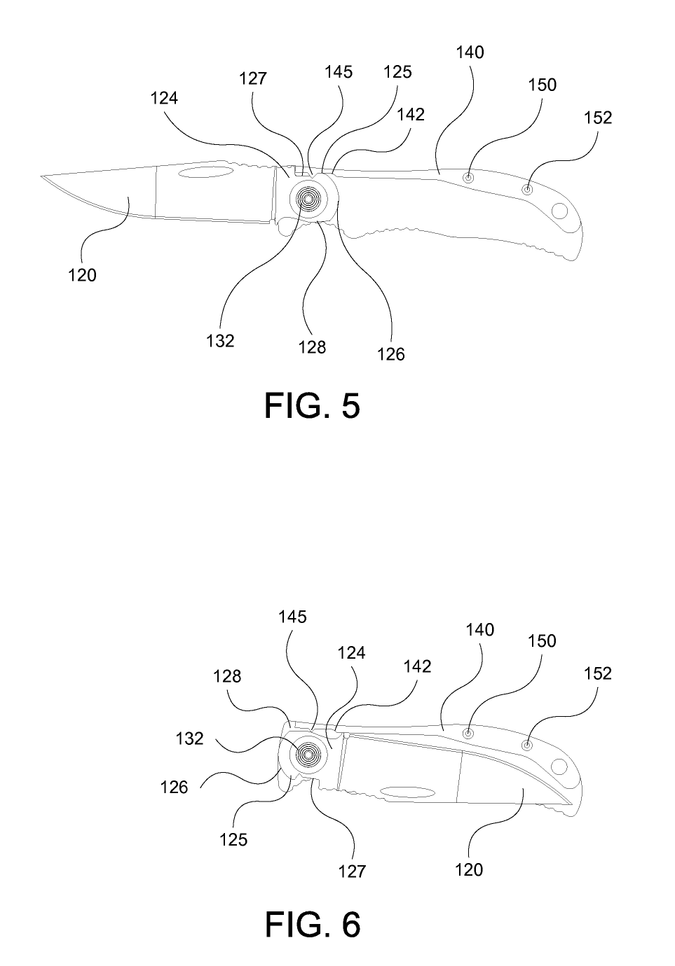

FIG. 5 is a section view of a knife having an embodiment slip joint with the blade 120 in an open position and the slip joint engaging the blade tang 124. Knife 110 includes a lockback bar 140 fasten to the handle with connector 150 and connector 152. Lockback bar 140 has an engaging surface including ramped surface 145 and indention 142. The tang of blade 120 includes a concave portion 127 prominent surface 125, radius or cam surface 126, and flat surface 128. In FIG. 5 the blade 120 is an open orientation and lockback bar 140 is engaging concave portion 127 with ramped surface 145. In a slip joint knife, lockback bar 140 does not positively lock blade 120 in an open or closed position, but provides a resistance to rotation of blade 120. In the present embodiment, the slip joint uses a lockback bar 140, however other embodiments may use other structure such as rocker arms, flat springs or other structures suitable for a slip joint.

In this embodiment, the ramped surface 145 does not fully lock the blade in an open position but it does provide greater rotational resistance in the open position than when the knife is in the closed position as depicted in FIG. 6 due to the difference in shape of flat surface 128 and concave portion 127 on the blade tang. By having a greater contour, or a sharp change in radius of the tang at concave portion 127, the ramped surface 145 will catch more on the greater contour and provide a greater resistance to rotation in the open position. This provides a more secure blade in the open position while also providing a respectively smaller opening rotation resistance making the knife easier to open.

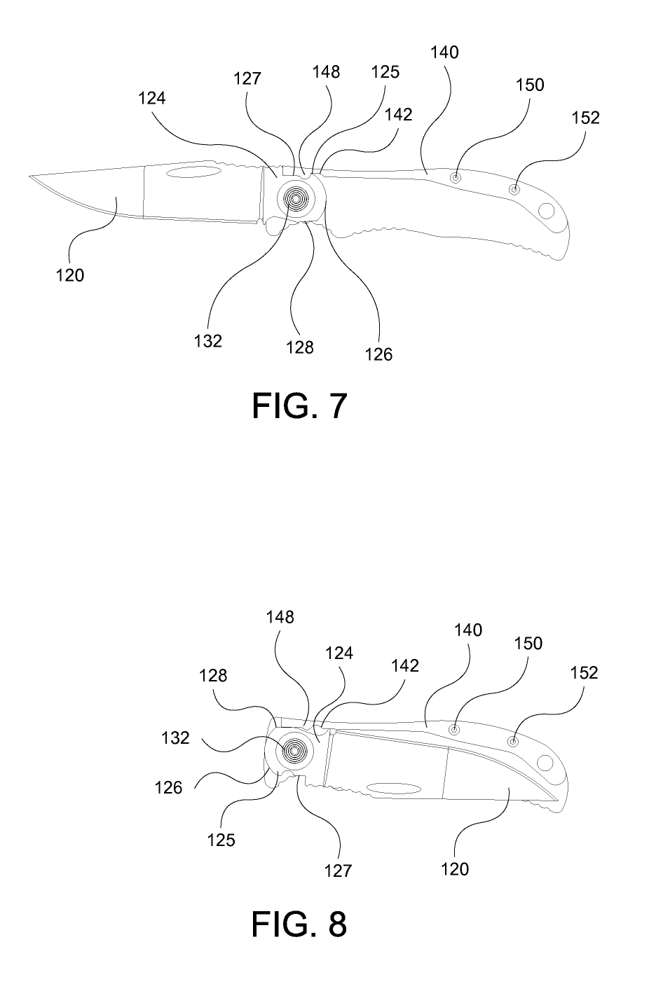

FIG. 7 is a section view of a knife having an embodiment slip joint with the blade 120 in an open position and the slip joint engaging the blade tang 124. Knife 110 includes a lockback bar 140 fasten to the handle with connector 150 and connector 152. Lockback bar 140 has an engaging surface including curved surface 148 and indention 142. As an example, the curved surface may be a ball to fit in a socket in the tang in a ball and socket arrangement; however other curved surfaces may be used within the principles of this disclosure. The tang of blade 120 includes a concave portion 127 prominent surface 125, radius or cam surface 126, and flat surface 128. In FIG. 5 the blade 120 is an open orientation and lockback bar 140 is engaging concave portion 127 with curved surface 148. In a slip joint knife, lockback bar 140 does not positively lock blade 120 in an open or closed position, but provides a resistance to rotation of blade 120. In the present embodiment, the slip joint uses a lockback bar 140, however other embodiments may use other structure such as rocker arms, flat springs or other structures suitable for a slip joint.

In this embodiment, the curved surface 148 does not fully lock the blade in an open position but it does provide greater rotational resistance in the open position than when the knife is in the closed position as depicted in FIG. 8 due to the difference in shape of flat surface 128 and concave portion 127 on the blade tang. By having a greater contour, or a sharp change in radius of the tang at concave portion 127, the curved surface 148 will catch more on the greater contour and provide a greater resistance to rotation in the open position. This provides a more secure blade in the open position while also providing a respectively smaller opening rotation resistance making the knife easier to open.

It will further be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of any of the above-described processes is not necessarily required to achieve the features and/or results of the embodiments described herein, but is provided for ease of illustration and description.

The subject matter of the present disclosure includes all novel and nonobvious combinations and subcombinations of the various processes, systems and configurations, and other features, functions, acts, and/or properties disclosed herein, as well as any and all equivalents thereof.

1. A slip joint knife comprising:
a handle having an opening to receive a blade, and a lock back bar having an engagement surface;
a pivot pin connected toward one end of the handle, the pivot pin to receive a blade; and
a blade to be rotatably attached to the handle using the pivot pin, the blade comprising a knife edge and a tang, wherein the tang includes a front portion and a rear portion where the front portion is on the knife edge side of the blade and the rear portion is on a substantially opposing surface of the tang, where the front portion has a substantially flatter geometry than the rear portion wherein the engagement surface of the tang provides a greater rotational resistance when in contact with the rear portion than with the front portion.
